(19) United States
(12) Patent Application Publication
(10) Pub. No.: US 2013/0157582 A1
(43) Pub. Date: Jun. 20, 2013

(54) WIRELESS COMMUNICATION DEVICE, COMMUNICATION SYSTEM AND CONTROL METHOD

(71) Applicant: Kouichi Tachikawa, Kanagawa (JP)

(72) Inventor: Kouichi Tachikawa, Kanagawa (JP)

(73) Assignee: KYOCERA CORPORATION, Kyoto (JP)

(21) Appl. No.: 13/818,498

(22) PCT Filed: Aug. 26, 2011
(86) PCT No.: PCT/JP2011/069265

§ 371 Date: Feb. 22, 2013

(30) Foreign Application Priority Data
Aug. 27, 2010 (JP) 2010-191442

(51) Int. Cl. H04B 7/08

(52) U.S. Cl. CPC H04B 7/08
USPC 455/68

(57) ABSTRACT

The wireless communication device includes: a receiving unit that receives radio waves emitted by a plurality of antennas of a base station, and transforms the radio waves into a signal; a signal processing unit that performs predetermined signal processing of the signal transformed by the reception unit; a detecting unit that detects a control channel in the signal processed by the signal processing unit; a field intensity calculation unit that calculates the field intensity for one period of the control channel in composite waves which periodically rotate; and a reception control unit that controls the reception unit so as to periodically receive the composite waves in the control channel on the basis of the calculation result calculated by the electric field intensity calculation unit.

### TECHNICAL FIELD

The present invention relates to a wireless communication device, a communication system, and a control method, all of which include a standby reception function.

### BACKGROUND ART

A wireless communication device including a standby reception function, such as standby for an incoming telephone call, performs regular confirmation for incoming calls or the like with a base station.

More specifically, for example, when a main power supply is turned on, a simplified mobile telephone device (PHS: Personal Handyphone System) receives control channels transmitted from a proximate base station, synchronizes with the control channel, then registers its location with the base station, and transitions to a standby state. In the standby state, control channels are intermittently received to obtain incoming data and the like.

Patent Document 1: Japanese Unexamined Patent Application, Publication No.H9-261153

### DISCLOSURE OF THE INVENTION

### Problems to be Solved by the Invention

Incidentally, when the wireless communication device receives control channels intermittently, the power consumption increases as compared to when there is no reception. Here, with the wireless communication device, when the intervals in intermittent reception are broadened, the power consumption is reduced, but reception of incoming calls and the like may be unexpectedly lost. On the other hand, when the intervals in intermittent reception are narrowed, reception of incoming calls and the like is less likely to be lost, but the power consumption increases.

An object of the present invention is to provide a wireless communication device, a communication system, and a control method, all of which are capable of reducing the power consumption by broadening intervals in intermittent reception while suppressing effects on incoming call rate.

### Means for Solving the Problems

In order to solve the above problems, a wireless communication device according to the present invention is a wireless communication device that communicates with a base station that has a plurality of antenna elements and an adaptive array function, in which directivity of composite waves generated by the plurality of antenna elements periodically rotates. The wireless communication device includes: a reception unit that receives radio waves emitted from the plurality of antenna elements of the base station, and converts the radio waves into signals; a signal processing unit that executes predetermined signal processing on the signals converted by the reception unit; a detection unit that detects control channels from the signals processed by the signal processing unit; a field intensity calculation unit that calculates field intensity for one period of the control channel in the composite waves that periodically rotate; and a control unit that controls the reception unit to periodically receive composite waves of the control channels, based on a result calculated by the field intensity calculation unit.

In the wireless communication device, it is preferable for the control unit to execute control such that, from among the composite waves of the control channels detected by the detection unit, a composite wave of the control channel in which the field intensity is at least a predetermined threshold value is selected as a composite wave to be received.

In the wireless communication device, it is preferable for the control unit to select, from among the composite waves of the control channels detected by the detection unit, the composite wave of the control channel with the highest field intensity, as a composite wave to be received.

In the wireless communication device, in a case in which the field intensity of all the control channels detected by the detection unit is lower than the predetermined threshold value based on the result calculated by the field intensity calculation unit, it is preferable for the control unit to control the reception unit to receive all the control channels detected by the detection unit.

In the wireless communication device, when the control unit is controlling the reception unit to periodically receive the composite waves of the control channels, in a case in which the field intensity of the control channels changes, it is preferable for the control unit to control the reception unit to receive all the control channels detected by the detection unit. In the wireless communication device, when the field intensity of the control channels is stabilized, it is preferable for the reception unit to be controlled to periodically receive composite waves of the control channels.

In the wireless communication device, it is preferable for the control unit to create an incoming call history showing reception time when a control channel representing an incoming call is received, and it is preferable for the control unit to control the reception unit to receive all control channels detected by the detection unit during a time period in which frequency of incoming calls shown in the incoming call history exceeds a predetermined number of times.

In order to solve the above problems, a communication system according to the present invention is a communication system that performs communication between a base station and a wireless communication device. The base station includes: a plurality of antenna elements that are spatially disposed at an interval of at least λ/2 (λ is the wavelength of radio waves used); a phase shift unit that detects the phase of a signal received by each of the plurality of antenna elements, and shifts the phase of a signal transmitted by the plurality of antenna elements based on a result of such detection; and a supply unit that supplies a signal, whose phase has been shifted by the phase shift unit, to the plurality of antenna elements by sequentially switching the signal so as to periodically rotate directivity characteristics of composite waves generated by the plurality of antenna elements. The wireless communication device includes: a reception unit that receives radio waves emitted from the plurality of antenna elements of the base station, and converts the radio waves into signals; a signal processing unit that executes predetermined signal processing on the signals converted by the reception unit; a detection unit that detects control channels from the signals processed by the signal processing unit; a field intensity calculation unit that calculates field intensity for one period of the control channel in the composite waves that periodically rotate; and a control unit that controls the reception unit to periodically receive composite waves of the control channels, based on a result calculated by the field intensity calculation unit.

In order to solve the above problems, a control method according to the present invention is a control method for a wireless communication device that communicates with a base station that includes: a plurality of antenna elements that are spatially disposed at an interval of at least λ/2 (λ is the wavelength of radio waves used); a phase shift unit that detects the phase of a signal received by each of the plurality of antenna elements, and shifts the phase of a signal transmitted by the plurality of antenna elements based on a result of such detection; and a supply unit that supplies a signal, whose phase has been shifted by the phase shift unit, to the plurality of antenna elements by sequentially switching the signal so as to periodically rotate directivity characteristics of composite waves generated by the plurality of antenna elements. The control method includes: a reception conversion step of receiving radio waves emitted from the plurality of antenna elements of the base station, and converts the radio waves into signals; a signal processing step of executing predetermined signal processing on the signals converted in the reception conversion step; a detection step of detecting control channels from the signals processed in the signal processing step; a field intensity calculation step of calculating field intensity for one period of the control channel in the composite waves that periodically rotate; and a control step of controlling the reception conversion step to periodically receive composite waves of the control channels, based on a result calculated in the field intensity calculation step.

### Effects of the Invention

According to the present invention, the power consumption can be reduced by broadening intervals in intermittent reception without affecting incoming call rate.

### BRIEF DESCRIPTION OF THE DRAWINGS

FIG. 1 is a block diagram showing a configuration of a wireless communication system;

FIG. 2 is a diagram illustrating transmission/reception slot timing between a base station and a PHS terminal;

FIG. 3 is a block diagram showing a configuration of the base station;

FIG. 4 a diagram illustrating arrangement of antenna elements;

FIG. 5 is a block diagram showing an example of a specific configuration of the base station;

FIG. 6 is a diagram schematically showing directivity characteristics of composite waves generated by the antenna elements;

FIG. 7 is a block diagram showing a configuration of the PHS terminal;

FIG. 8 is a diagram for illustrating a control channel pattern; and

FIG. 9 is a flowchart for illustrating operations of the PHS terminal.

### PREFERRED MODE FOR CARRYING OUT THE INVENTION

Descriptions are provided hereinafter regarding an example of a preferred embodiment of the present invention. The present embodiment is described by assuming a PHS (Personal Handyphone System) terminal as a specific example of a wireless communication device, but the wireless communication device is not limited thereto, as long as a function of performing standby reception is provided. Therefore, the present invention is applicable to various devices, such as a mobile telephone device or a PDA (Personal Digital Assistant) whose usable frequency band and modulation technique are different from those of a PHS terminal.

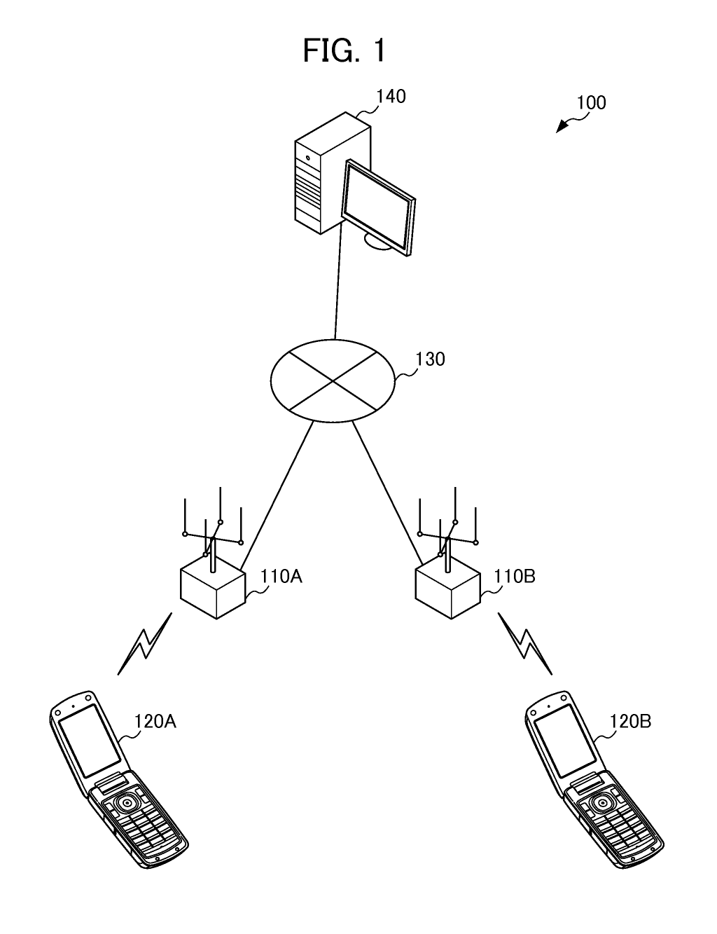

FIG. 1 shows a schematic connection relationship in a wireless communication system 100. The wireless communication system 100 is configured to include: a plurality of base stations (only base stations 110A and 110B are illustrated in the example shown in FIG. 1); a plurality of PHS terminals (only PHS terminals 120A and 120B are illustrated in the example shown in FIG. 1); a communication network 130 configured by an optical fiber or an ISDN line; and a proxy server 140.

In the wireless communication system 100, in a case in which a user connects a communication line from his/her own PHS terminal 120A to another PHS terminal 120B, the PHS terminal 120A executes OpenSearch, and makes a wireless connection request for a base station 110A having the best communication quality within the communication range.

Upon receiving the wireless connection request, the base station 110A makes a request for a communication connection with a communication partner, to the proxy server 140 via the communication network 130. The proxy server 140 refers to location registration information of the PHS terminal 120B, selects a base station (the base station 110B in the example shown in FIG. 1) within a wireless communication range of the PHS terminal 120B, secures a communication path between the base station 110A and the base station 110B, and establishes communication between the PHS terminal 120A and the PHS terminal 120B.

Various techniques for improving the speed and quality of communication among each device are employed in this type of wireless communication system 100. In the present embodiment, for example, wireless communication conforming to a TDMA (Time Division Multiple Access)-TDD (Time Division Duplex) scheme is performed among the base stations 110A and 110B and the PHS terminals 120A and 120B.

The base station 110A transmits a control channel (CCH: Control CHannel) at timing in a predetermined pattern, and the control channel includes a broadcasting channel (BCCH: Broadcast Control CHannel), a paging channel (PCH: Paging CHannel), and a link channel allocation signal (downlink SCCH: Signaling Control CHannel).

The BCCH is a signal including information for location registration, information regarding a channel structure, and system information. The BCCH is transmitted from the base station 110A to the PHS terminal 120A by broadcasting. The PCH is a signal for providing an incoming call notification to the PHS terminal 120A within a general calling area, when there is an incoming call request. The downlink SCCH is a signal including information necessary for call connection.

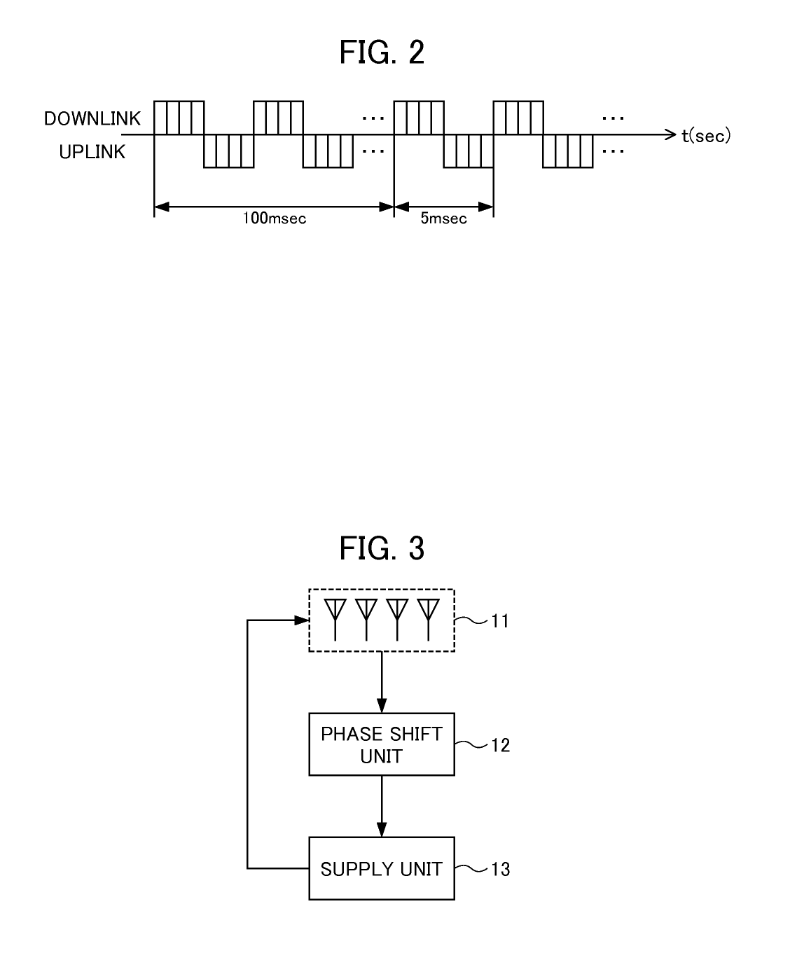

As shown in FIG. 2, in the TDMA-TDD scheme which is the communication scheme of the present embodiment, a frame (time interval) for transmitting a signal from the base station 110A to the PHS terminal 120A is made different from a frame (time interval) for transmitting a signal from the PHS terminal 120A to the base station 110A. Herein, the frame for transmitting a signal from the base station 110A to the PHS terminal 120A is referred to as a downlink (downstream); and the frame for transmitting a signal from the PHS terminal 120A to the base station 110A is referred to as an uplink (upstream).

In ARIBSTD-28, each frame is configured as a time slot (a TDMA slot), in which each of the downlink and uplink is divided into four in a temporal axis direction. A time length of a single time slot is 625 microseconds; and a time length of eight time slots is 5 milliseconds. A general PHS terminal checks presence or absence of an incoming call by performing intermittent reception of CCH in every 1.2 seconds.

The PHS terminal 120A according to the present embodiment has a function of reducing the power consumption by extending the timing of intermittent reception without affecting the incoming call rate, by further reducing intermittent reception.

Descriptions are hereinafter provided for specific configurations and operations of the base stations 110A and 110B as well as the PHS terminals 120A and 120B, in the wireless communication system 100. In the following embodiment, a configuration of the base station 110A is described as representing both the base stations 110A and 110B that have a similar configuration; and a configuration of the PHS terminal 120A is described as representing both the PHS terminals 120A and 120B that have a similar configuration.

As shown in FIG. 3, the base station 110A has a plurality of antenna elements 11, a phase shift unit 12, and a supply unit 13.

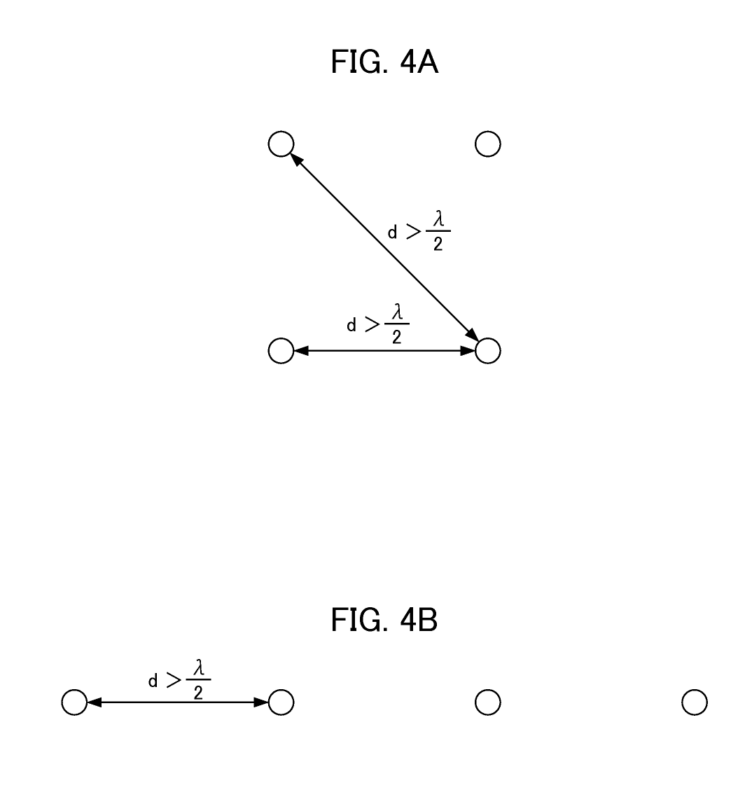

The plurality of antenna elements 11 are spatially disposed at an interval of at least λ/2 (λ is the wavelength of radio waves used). Here, for example, a method of planarly disposing the antenna elements 11 at an interval of at least λ/2 (see FIG. 4A), or a method of linearly disposing the antenna elements 11 at a predetermined interval (see FIG. 4B) is conceivable as a method of disposing the antenna elements 11. FIG. 4 is a schematic diagram illustrating the antenna elements 11 from the top. The example shown in FIG. 4 illustrates the configuration of the four antenna elements 11, but the number of the antenna elements 11 is not limited thereto. The interval between the plurality of antenna elements 11 is preferably about 5λ on an empirical basis, in view of various factors such as mechanical intensity, the size of the area covered by a base station (about 500 m), the output level (about 500 mW), the usable frequency band (1.9 GHz band), and an adaptive antenna array configuration.

Since the antenna elements 11 are disposed at the interval of at least λ/2 in each base station, the wireless communication system 100 implements a system that combines both an antenna gain by phase synthesis as a characteristic of an array antenna, and a spatial diversity gain.

By arranging the plurality of antenna elements 11 at a predetermined interval, the base station 110A employs an adaptive antenna system (AAS) that adaptively controls directivity characteristics of radio waves, and thus can dynamically change directivity of radio waves to be transmitted and received by beam forming.

By the beam forming, a base station proximate to the base station 110A can use the same frequency band; therefore, the use efficiency of radio waves is considerably increased.

More specifically, the wireless communication system 100 utilizes two techniques in combination: a technique (null steering) for preventing radio waves from being transmitted in a direction of an interfering station, and preventing radio waves from being received from such a direction; and a technique (beam steering) for intensively transmitting radio waves of the base station in a particular direction. Thus, in the wireless communication system 100, the null steering prevents interference between base stations as well as between a terminal and a base station, and the beam steering allows a base station to communicate with a terminal that is farther away from the base station.

The phase shift unit 12 detects the phase of a signal received by each of the plurality of antenna elements 11, and shifts the phase of a signal transmitted by the plurality of antenna elements 11 based on a result of the detection. The supply unit 13 supplies a signal, whose phase has been shifted by the phase shift unit 12, to the plurality of antenna elements 11 by sequentially switching the signal so as to periodically rotate the directivity characteristics of a composite wave generated by the plurality of antenna elements 11.

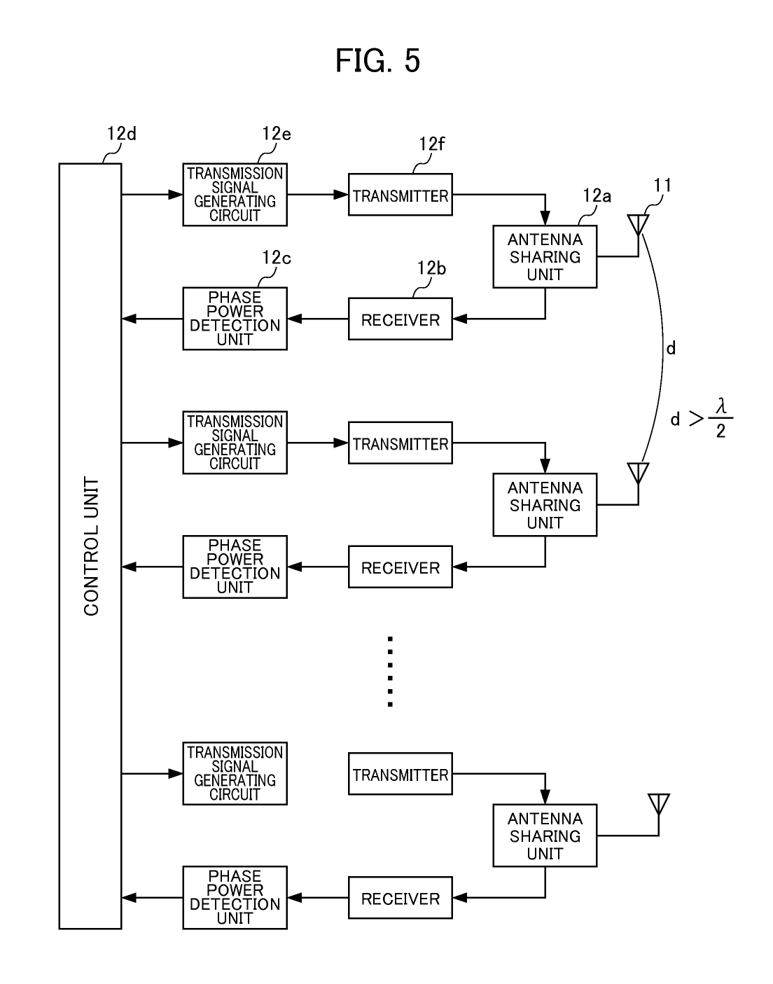

More specifically, as shown in FIG. 5, the base station 110A is configured by an antenna sharing unit 12a, a receiver 12b, a phase power detection unit 12c, a control unit 12d, a transmission signal generation unit 12e, and a transmitter 12f. The antenna sharing unit 12a, the receiver 12b, the phase power detection unit 12c, the transmission signal generation unit 12e and the transmitter 12f correspond to the phase shift unit 12. The control unit 12d corresponds to the supply unit 13.

The antenna sharing unit 12a switches connection of the antenna elements 11 to the receiver 12b or the transmitter 12f in accordance with control by the control unit 12d. The receiver 12b is disposed for each of the antenna elements 11, and demodulates a signal received by each of the antenna elements 11.

Based on the signal demodulated by the receiver 12b, the phase power detection unit 12c detects phase and power. Based on the result detected by the phase power detection unit 12c, the control unit 12d calculates the phase and power of a transmission signal. Based on the result calculated by the control unit 12d, the transmission signal generation unit 12e generates a transmission signal having a predetermined phase and power. When the transmission signal generation unit 12e generates a transmission signal, the transmitter 12f modulates the transmission signal to be transmitted from each of the antenna elements 11.

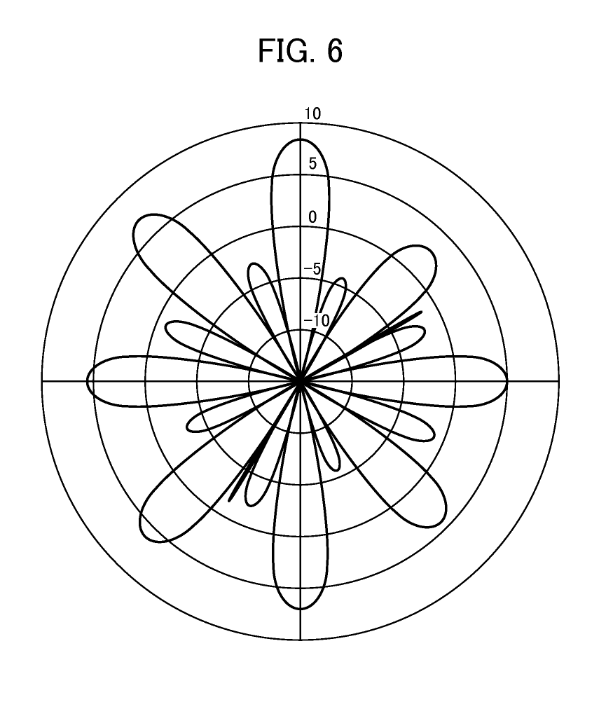

In this manner, the base station 110A configures an adaptive array function in which the interval between the antenna elements 11 is at least λ/2. Therefore, the base station 110A does not form a radio emission beam with unidirectionally biased directivity characteristics, but implements a radiating pattern with a large number of peaks appearing substantially equally in each direction of all the 360-degree directions (see FIG. 6), and executes control so as to periodically rotate the directivity characteristics.

Next, descriptions are provided for a configuration and operations of the PHS terminal 120A.

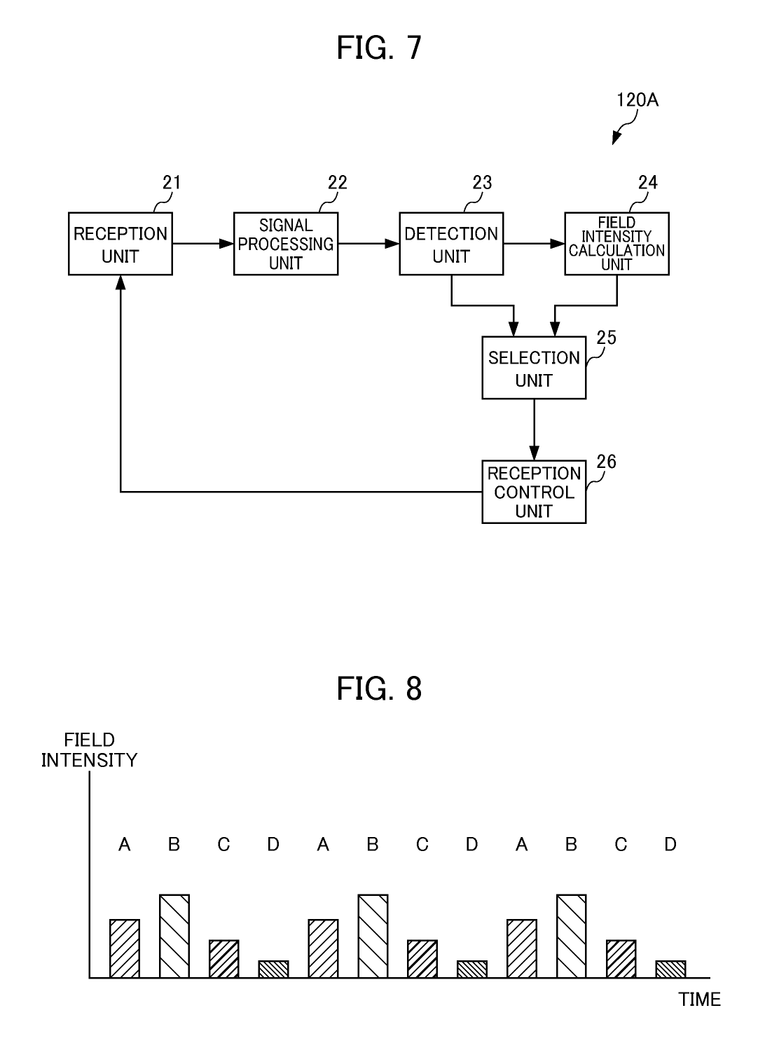

As shown in FIG. 7, the PHS terminal 120A has a reception unit 21, a signal processing unit 22, a detection unit 23, a field intensity calculation unit 24, a selection unit 25, and a reception control unit 26 (the control unit). The selection unit 25 and the reception control unit 26 may be integrally configured.

The reception unit 21 receives radio waves emitted from the plurality of antenna elements 11 of the base station 110A, and converts the radio waves into signals. The signal processing unit 22 executes predetermined signal processing on the signals converted by the reception unit 21. The detection unit 23 detects control channels (mainly referring to PCH, and the same applies hereinafter) from the signals processed by the signal processing unit 22.

The field intensity calculation unit 24 calculates field intensity for one period of the control channel, in periodically rotating composite waves. More specifically, when the detection unit 23 detects the control channels for one cycle with rotating directivity characteristics, the field intensity calculation unit 24 calculates field intensity of each of the control channels. Based on the result calculated by the field intensity calculation unit 24, the selection unit 25 selects a control channel to be received, from the control channels detected by the detection unit 23.

The reception control unit 26 controls the reception unit 21 to periodically receive only a control channel selected by the selection unit 25.

In this manner, the PHS terminal 120A periodically receives only a selected control channel. Therefore, the interval at which control channels are received is longer than an ordinary interval (for example, 1.2 seconds), the power consumption can be reduced, and the deterioration of the incoming call rate can be prevented because intermittent reception of a control channel does not occur over a long time period.

It is preferable for the reception control unit 26 to be configured to execute control such that, from among the composite waves of the control channels detected by the detection unit 23, a composite wave of a control channel with field intensity being at least a predetermined threshold value is selected as a composite wave to be received. Such selection may be executed by the selection unit 25.

For example, in a case in which control channels rotate in four patterns of A, B, C and D as shown in FIG. 8, the PHS terminal 120A selects a control channel B with the highest field intensity as a control channel to be received.

For example, in a case in which the capacity of a battery (not shown) that supplies power to the PHS terminal 120A is 700 milliampere-hours, in a standby state for communication (a state of waiting for only incoming telephone calls and/or arriving mail), when the current to be used by receiving a control channel is assumed to be 1 milliampere, standby duration for communication is 700 hours (700 milliampere-hours/1 milliampere=700 hours).

By assuming that 600 microamperes are consumed when a control channel is not being received, i.e. when the main power supply is turned on and no processing is being executed, the current required for receiving a control channel is 400 microamperes (1 milliampere−600 microamperes=400 microamperes).

According to the present embodiment, in a case in which standby is performed for only one rotation among four rotations by reducing three rotations, the current for standby reception is 100 microamperes, obtained by dividing 400 microamperes by 4, and the standby current is 700 microamperes obtained by adding 600 microamperes to 100 microamperes (600 microamperes+100 microamperes=700 microamperes).

Therefore, when the present embodiment is applied, in a case in which the capacity of the battery is 700 milliampere-hours, the standby duration is 1,000 hours (700 milliampere-hours/700 microamperes=1,000 hours), and the standby duration can be extended by about 30% as compared to a case in which the present embodiment is not applied.

In this manner, since the PHS terminal 120A periodically receives only a control channel with the highest field intensity, intervals at which a control channel are received are longer than an ordinary interval (for example, 1.2 seconds), and the power consumption can be reduced; and since non-reception of a control channel for an extended period of time does not occur, deterioration in incoming call rate can be prevented.

It is preferable for the reception control unit 26 to select, from among the composite waves of the control channels detected by the detection unit 23, a composite wave of a control channel with the highest field intensity as a composite wave to be received. Such selection may be executed by the selection unit 25.

Therefore, since the PHS terminal 120A periodically receives only a control channel with the highest field intensity in a good reception environment, intervals at which control channels are received are longer than 1.2 seconds, and the power consumption can be reduced; and since non-reception of a control channel for an extended period of time does not occur, deterioration in incoming call rate can be prevented.

In a case in which the field intensity of all the control channels detected by the detection unit 23 is lower than the predetermined threshold value based on the result calculated by the field intensity calculation unit 24, it is preferable for the reception control unit 26 to control the reception unit 21 to receive all the control channels detected by the detection unit 23.

Here, the field intensity being lower than the predetermined threshold value means that the electric field is weak, and the reception environment has deteriorated.

Therefore, since the PHS terminal 120A is switched to periodically receive all control channels in a case in which the reception environment has deteriorated, deterioration in incoming call rate can be prevented in a weak electric field.

When the reception control unit 26 controls the reception unit 21 to periodically receive composite waves of control channels, in a case in which the field intensity of the control channels changes, it is preferable for the reception control unit 26 to control the reception unit 21 to receive all the control channels detected by the detection unit 23.

When the reception environment changes with surrounding state during movement of the PHS terminal 120A, the field intensity may also change. Therefore, for the PHS terminal 120A, the control channels that are periodically received before movement may not have optimum field intensity during movement.

Therefore, in a case in which the field intensity changes, the PHS terminal 120A prevents deterioration in incoming call rate, by executing control so as to switch to periodically receive all control channels.

It is preferable for the reception control unit 26 to create an incoming call history showing reception time when receiving a control channel representing an incoming call. During a time period in which the frequency of incoming calls shown in the incoming call history exceeds a predetermined number of times, it is preferable for the reception control unit 26 to control the reception unit 21 to receive all control channels detected by the detection unit 23.

With the PHS terminal 120A, if control to reduce reception of control channels according to the present invention is executed during a time period when incoming calls are frequent, an incoming call response may deteriorate due to failure in reception or the like.

Accordingly, regarding a time period (for example, daytime or evening) during which the incoming call response is assumed to deteriorate based on the incoming call history, the PHS terminal 120A determines that such a time period is outside the time period of reduced reception, and control to reduce reception of control channels is not executed during the period.

During a time period in which the frequency of incoming calls shown in the incoming call history exceeds a predetermined number of times, the reception control unit 26 controls the reception unit 21 to receive all control channels detected by the detection unit 23; therefore, the PHS terminal 120A can prevent deterioration in incoming call rate.

On the other hand, the PHS terminal 120A periodically receives only a selected control channel during a time period in which the frequency of incoming calls shown in the incoming call history does not exceed a predetermined number of times. Therefore, the intervals at which control channels are received are longer than an ordinary interval (for example, 1.2 seconds), the power consumption can be reduced, and the deterioration in incoming call rate can be prevented because non-reception of a control channel does not occur for an extended period of time.

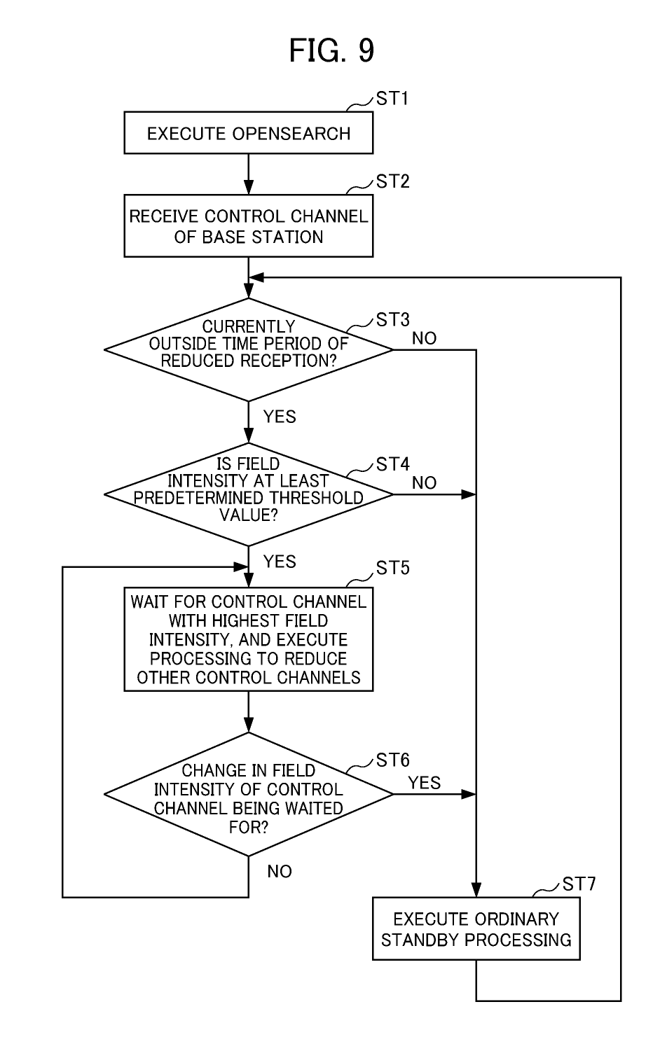

Next, descriptions are provided for operations of the PHS terminal 120A with reference to a flowchart shown in FIG. 9.

In Step ST1, after the main power supply is turned ON, the PHS terminal 120A executes OpenSearch. The PHS terminal 120A determines a base station that is suitable for standby as a result of the OpenSearch, and executes synchronous processing.

In Step ST2, the PHS terminal 120A receives a control channel of the base station that was determined in the processing in Step ST1.

In Step ST3, based on the incoming call history, the PHS terminal 120A determines whether the present time is outside the time period of reduced reception. In a case in which the present time is determined to be outside the time period of reduced reception (Yes), the processing advances to Step ST4. In a case in which the present time is determined to be not outside the time period of reduced reception (No), the processing advances to Step ST7.

In Step ST4, the PHS terminal 120A determines whether field intensity of the control channel received in the processing in Step ST2 is at least a predetermined threshold value. In a case in which the field intensity is determined to be at least the predetermined threshold value (Yes), the processing advances to Step ST5. In a case in which the field intensity is determined to be below the predetermined threshold value (No), the processing advances to Step ST7.

In Step ST5, the PHS terminal 120A waits for a control channel that was determined to have the highest field intensity in the processing in Step ST4, and executes processing to reduce other control channels.

In Step ST6, the PHS terminal 120A determines whether there is any change in the field intensity of the control channel that is being waited for. In a case in which the field intensity is determined to be changing (Yes), the processing advances to Step ST7. In a case in which the field intensity is determined to be not changing (No), the processing returns to Step ST5.

In Step ST7, the PHS terminal 120A does not execute processing to reduce reception of control channels, but executes ordinary waiting processing (for example, processing to receive a control channel every 1.2 seconds).

Subsequently, the PHS terminal 120A periodically advances to Step ST3, determines whether the present time is outside the time period of reduced reception based on the incoming call history, and repeats the processing of Steps ST3 to ST7.

In this manner, the PHS terminal 120A periodically receives only a selected control channel. Therefore, the intervals at which control channels are received are longer than an ordinary interval (for example, 1.2 seconds), the power consumption can be reduced, and the deterioration in incoming call rate can be prevented because intermittent reception of a control channel does not occur for an extended period of time.

### EXPLANATION OF REFERENCE NUMERALS

21 reception unit

22 signal processing unit

23 detection unit

24 field intensity calculation unit

25 selection unit

26 reception control unit (control unit)

100 wireless communication system

110A, 110B base station

120A, 120B PHS terminal

1. A wireless communication device that communicates with a base station that has a plurality of antenna elements and an adaptive array function, in which directivity of composite waves generated by the plurality of antenna elements periodically rotates, the wireless communication device comprising:
a reception unit that receives radio waves emitted from the plurality of antenna elements of the base station, and converts the radio waves into signals;
a signal processing unit that executes predetermined signal processing on the signals converted by the reception unit;
a detection unit that detects control channels from the signals processed by the signal processing unit;
a field intensity calculation unit that calculates field intensity for one period of the control channel in the composite waves that periodically rotate; and
a control unit that controls the reception unit to periodically receive composite waves of the control channels, based on a result calculated by the field intensity calculation unit.

2. The wireless communication device according to claim 1,
wherein the control unit executes control such that, from among the composite waves of the control channels detected by the detection unit, a composite wave of the control channel in which the field intensity is at least a predetermined threshold value is selected as a composite wave to be received.

3. The wireless communication device according to claim 1,
wherein the control unit selects, from among the composite waves of the control channels detected by the detection unit, the composite wave of the control channel with the highest field intensity, as a composite wave to be received.

4. The wireless communication device according to claim 1,
wherein, in a case in which the field intensity of all the control channels detected by the detection unit is lower than the predetermined threshold value based on a result calculated by the field intensity calculation unit, the control unit controls the reception unit to receive all the control channels detected by the detection unit.

5. The wireless communication device according to claim 1,
wherein, when the control unit is controlling the reception unit to periodically receive the composite waves of the control channels, in a case in which the field intensity of the control channels changes, the control unit controls the reception unit to receive all the control channels detected by the detection unit.

6. The wireless communication device according to claim 1,
wherein the control unit creates incoming call history showing reception time when a control channel representing an incoming call is received, and the control unit controls the reception unit to receive all control channels detected by the detection unit during a time period in which frequency of incoming calls shown in the incoming call history exceeds a predetermined number of times.

7. A communication system that performs communication between a base station and a wireless communication device,
wherein the base station comprises:
a plurality of antenna elements that are spatially disposed at an interval of at least λ/2 (λ is the wavelength of radio waves used);
a phase shift unit that detects phase of a signal received by each of the plurality of antenna elements, and shifts phase of a signal transmitted by the plurality of antenna elements based on a result of such detection; and
a supply unit that supplies a signal, whose phase has been shifted by the phase shift unit, to the plurality of antenna elements by sequentially switching the signal so as to periodically rotate directivity characteristics of composite waves generated by the plurality of antenna elements, and
wherein the wireless communication device comprises:
a reception unit that receives radio waves emitted from the plurality of antenna elements of the base station, and converts the radio waves into signals;
a signal processing unit that executes predetermined signal processing on the signals converted by the reception unit;
a detection unit that detects control channels from the signals processed by the signal processing unit;
a field intensity calculation unit that calculates field intensity for one period of the control channel in the composite waves that periodically rotate; and
a control unit that controls the reception unit to periodically receive composite waves of the control channels, based on a result calculated by the field intensity calculation unit.

8. A control method for a wireless communication device that communicates with a base station that includes: a plurality of antenna elements that are spatially disposed at an interval of at least λ/2 (λ is the wavelength of radio waves used); a phase shift unit that detects phase of a signal received by each of the plurality of antenna elements, and shifts phase of a signal transmitted by the plurality of antenna elements based on a result of such detection; and a supply unit that supplies a signal, whose phase has been shifted by the phase shift unit, to the plurality of antenna elements by sequentially switching the signal so as to periodically rotate directivity characteristics of composite waves generated by the plurality of antenna elements, the control method comprising:
a reception conversion step of receiving radio waves emitted from the plurality of antenna elements of the base station, and converts the radio waves into signals;
a signal processing step of executing predetermined signal processing on the signals converted in the reception conversion step;
a detection step of detecting control channels from the signals processed in the signal processing step;
a field intensity calculation step of calculating field intensity for one period of the control channel in the composite waves that periodically rotate; and
a control step of controlling the reception conversion step to periodically receive composite waves of the control channels, based on a result calculated in the field intensity calculation step.
